(19) United States
(12) Patent Application Publication
(10) Pub. No.: US 2011/0191764 A1
(43) Pub. Date: Aug. 4, 2011

(54) SYSTEMS, METHODS, AND APPARATUSES FOR FACILITATING DISTRIBUTION OF FIRMWARE UPDATES

(75) Inventor: Alexander PIORECKI, Malmo (SE)

(73) Assignee: NOKIA CORPORATION, Espoo (FI)

(21) Appl. No.: 13/014,669

(22) Filed: Jan. 26, 2011

Related U.S. Application Data
(60) Provisional application No. 61/301,391, filed on Feb. 4, 2010.

(51) Int. Cl. G06F 9/44

(52) U.S. Cl. 717/172; 717/168

(57) ABSTRACT

Methods, apparatuses, and systems are provided for facilitating distribution of firmware updates. A method may include receiving a bundled firmware update package. The bundled firmware update package may include a plurality of firmware update packages. The method may further include extracting a firmware update package from the bundled firmware update package. The method may additionally include using the extracted firmware update package to update firmware installed on an apparatus. Corresponding apparatuses and systems are also provided.

### RELATED APPLICATION

This application claims priority to U.S. Application No. 61/301,391 filed Feb. 4, 2010, which is incorporated herein by reference in its entirety.

### TECHNOLOGICAL FIELD

Embodiments of the present invention relate generally to communications technology and, more particularly, relate to systems, methods, and apparatuses facilitating distribution of firmware updates.

### BACKGROUND

The modern computing era has brought about a tremendous expansion in computing power as well as increased portability and affordability of computing devices. As a result, consumers from all walks of life now utilize a variety of computing devices in their everyday lives. These computing devices may be at least partially controlled by firmware. Manufacturers of computing devices often issue updates to firmware for computing devices already on the market in order to update device features, fix bugs in an earlier version of the firmware, and/or the like. Devices running on outdated firmware may offer a negative user experience, which may reflect poorly on the manufacturer in the minds of consumers. Accordingly, manufacturers may desire that computing devices be updated to the most recent firmware version. However, distributing firmware updates to computing devices after they are in the hands of consumers may be troublesome.

### BRIEF SUMMARY

Systems, methods, apparatuses, and computer program products described herein facilitate distribution of firmware updates. The systems, methods, apparatuses, and computer program products provided in accordance with example embodiments of the invention may provide several advantages to network service providers, device manufacturers, firmware venders, computing devices, and computing device users. Example embodiments of the invention provide a bundled firmware update package that comprises a plurality of firmware update packages. Such example embodiments may facilitate easier distribution of firmware updates in environments where apparatuses having varying versions of firmware are deployed. In this regard, a disseminating device may distribute a bundled firmware update package in accordance with embodiments of the invention without considering a receiving device's current firmware. Further, for purposes of device-to-device distribution, bundled firmware update packages in accordance with example embodiments of the invention may facilitate a more rapid distribution of firmware updates to a community of apparatuses. Example embodiments of the invention additionally provide apparatuses considered to receive bundled firmware update packages over one or more of a proximity-based communication link from another apparatus or via a memory card inserted into a memory card slot. Such example embodiments may allow a user to update the firmware in an apparatus without requiring access to a personal computer and data cable for transfer of a firmware update from the personal computer to the apparatus. Further, such example embodiments may save a user from incurring data transfer fees that might otherwise be incurred if the user were to download a firmware over the air (FOTA) update via a cellular network. Additionally, if a user is located in an area without a network that provides data service suitable for distribution of firmware updates, example embodiments of the invention may still allow the user to update firmware in an apparatus.

In a first example embodiment, a method is provided, which comprises receiving a bundled firmware update package. The bundled firmware update package of this embodiment comprises a plurality of firmware update packages. The method of this embodiment further comprises extracting a firmware update package from the bundled firmware update package. The method of this embodiment additionally comprises using the extracted firmware update package to update firmware installed on an apparatus.

In another example embodiment, an apparatus is provided. The apparatus of this embodiment comprises at least one processor and at least one memory storing computer program code, wherein the at least one memory and stored computer program code are configured to, with the at least one processor, cause the apparatus to at least receive a bundled firmware update package. The bundled firmware update package of this embodiment comprises a plurality of firmware update packages. The at least one memory and stored computer program code are configured to, with the at least one processor, further cause the apparatus of this embodiment to extract a firmware update package from the bundled firmware update package. The at least one memory and stored computer program code are configured to, with the at least one processor, additionally cause the apparatus of this embodiment to use the extracted firmware update package to update firmware installed on an apparatus.

In another example embodiment, a computer program product is provided. The computer program product of this embodiment includes at least one computer-readable storage medium having computer-readable program instructions stored therein. The program instructions of this embodiment comprise program instructions configured to receive a bundled firmware update package. The bundled firmware update package of this embodiment comprises a plurality of firmware update packages. The program instructions of this embodiment further comprise program instructions configured to extract a firmware update package from the bundled firmware update package. The program instructions of this embodiment also comprise program instructions configured to use the extracted firmware update package to update firmware installed on an apparatus.

In another example embodiment, an apparatus is provided that comprises means for receiving a bundled firmware update package. The bundled firmware update package of this embodiment comprises a plurality of firmware update packages. The apparatus of this embodiment further comprises means for extracting a firmware update package from the bundled firmware update package. The apparatus of this embodiment additionally comprises means for using the extracted firmware update package to update firmware installed on an apparatus.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of a system for facilitating distribution of firmware updates according to an example embodiment of the present invention;

FIG. 2 illustrates a block diagram of a system for facilitating distribution of firmware updates according to an example embodiment of the present invention;

FIG. 3 is a schematic block diagram of a mobile terminal according to an example embodiment of the present invention;

FIG. 4 illustrates a block diagram of a user apparatus for facilitating distribution of firmware updates according to an example embodiment of the invention;

FIG. 5 illustrates a bundled firmware update package according to an example embodiment of the invention;

FIG. 6 illustrates a block diagram of a package generation apparatus for generating a bundled firmware update package according to an example embodiment of the invention; and

FIG. 7 illustrates a flowchart according to an example method for distributing and updating firmware according to an example embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

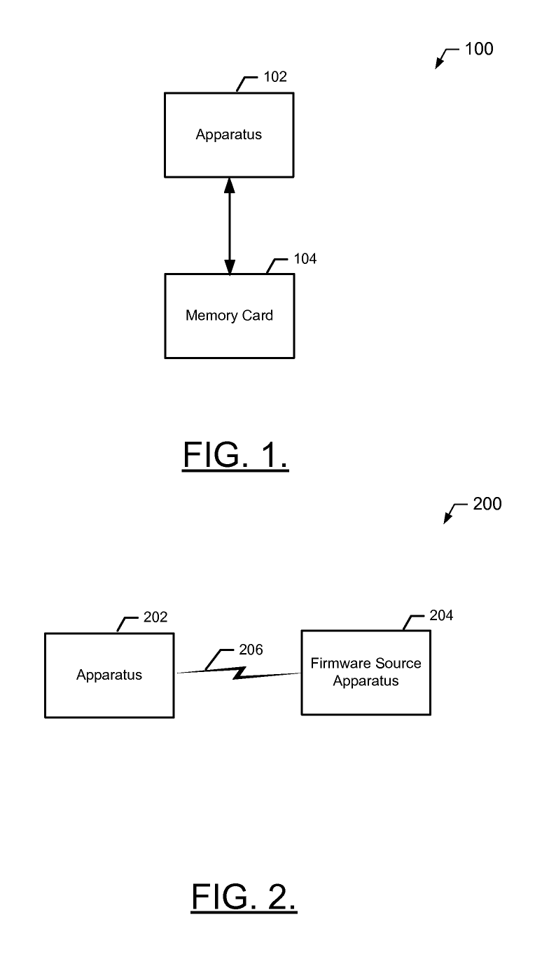

FIG. 1 illustrates a block diagram of a system 100 for facilitating distribution of firmware updates according to an example embodiment of the present invention. It will be appreciated that the system 100 as well as the illustrations in other figures are each provided as an example of one embodiment of the invention and should not be construed to narrow the scope or spirit of the invention in any way. In this regard, the scope of the disclosure encompasses many potential embodiments in addition to those illustrated and described herein. As such, while FIG. 1 illustrates one example of a configuration of a system for facilitating distribution of firmware updates, numerous other configurations may also be used to implement embodiments of the present invention.

In at least some embodiments, the system 100 includes an apparatus 102 and a memory card 104. The apparatus 102 may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), remote control, any combination thereof, and/or the like.

The apparatus 102 may comprise a receptacle for receiving a memory card 104. The memory card 104 may comprise any memory apparatus configured for insertion in or coupling with the receptacle of the apparatus 102. In an example embodiment, the memory card 104 comprises a flash memory card. One or more firmware update packages, such as, for example, a bundled firmware update package may be stored on the memory card 104. Accordingly, in an example embodiment, the apparatus 102 is configured to access a firmware update package stored on a memory card 104 when the memory card 104 is coupled to the apparatus 102 via a memory card receptacle.

FIG. 2 illustrates a block diagram of another system for facilitating distribution of firmware updates according to an example embodiment of the present invention. In at least some embodiments, the system 200 comprises an apparatus 202 and a firmware source apparatus 204 in communication via a communication link 206. The apparatus 202 may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), remote control, any combination thereof, and/or the like.

The firmware source apparatus 204 may comprise any computing device configured to provide a firmware update package (e.g., a bundled firmware update package) to the apparatus 202 over the communication link 206. In this regard, the firmware source apparatus 204 may comprise in various example embodiments, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), remote control, server, network node, any combination thereof, and/or the like.

The communication link 206 may comprise any communication link by which the apparatus 202 and firmware source apparatus 204 may communicate such that the apparatus 202 can receive a firmware update package provided to the apparatus 202 by the firmware source apparatus 204. In an example embodiment, the communication link 206 comprises a proximity-based communication link. The proximity-based communication link may comprise a Bluetooth communication link, a Bluetooth low energy communication link, a communication link implementing an Institute of Electrical and Electronics Engineers 802.15 standard, a ZigBee communication link, an Ultra-Wideband communication link, a near field communication link, an infrared communication link, a wireless local area network (WLAN) communication link, or the like.

Accordingly, in an example embodiment, the apparatus 202 is configured to receive a firmware update package provided to the apparatus 202 by the firmware source apparatus 204 over the communication link 206. The firmware update package provided by the firmware source apparatus 204 may be stored on the firmware source apparatus 204 or may be stored on a remote network apparatus and forwarded to the apparatus 202 by the firmware source apparatus 204.

In an example embodiment of the invention, an apparatus is provided that is configured to provide the functionality of both an apparatus 102 and an apparatus 202. In this regard, an apparatus in accordance with an example embodiment may be configured to receive a firmware update package by accessing a firmware update package stored on a memory card 104 and by receiving a firmware update package provided by a firmware source apparatus 204 over a communication link 206.

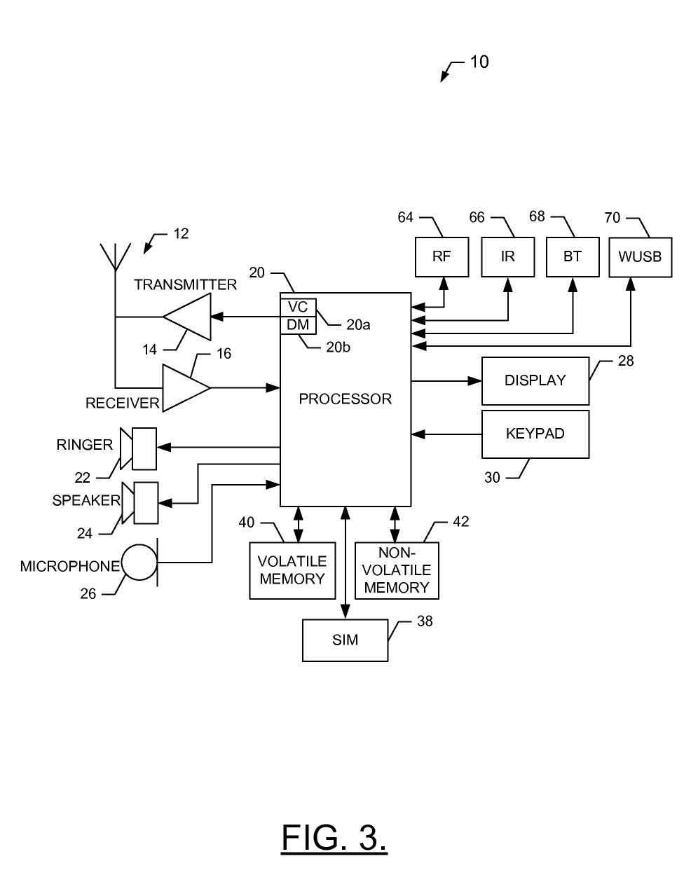

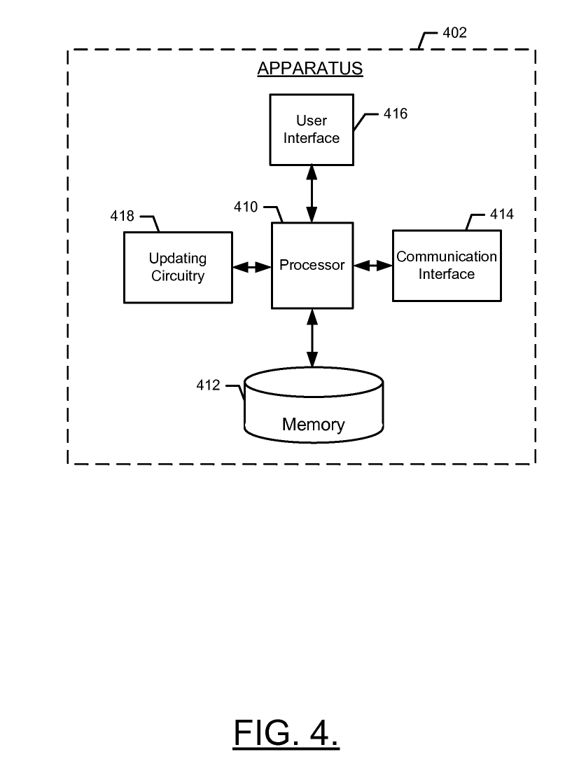

In an example embodiment, one or more of the apparatus 102, apparatus 202, firmware source apparatus 204, or apparatus 402 (see, FIG. 4) is embodied as a mobile terminal, such as that illustrated in FIG. 3. In this regard, FIG. 3 illustrates a block diagram of a mobile terminal 10 representative of one embodiment of an apparatus 102, apparatus 202, firmware source apparatus 204, and/or apparatus 402 in accordance with embodiments of the present invention. It should be understood, however, that the mobile terminal 10 illustrated and hereinafter described is merely illustrative of one type of apparatus 102, apparatus 202, firmware source apparatus 204, and/or apparatus 402 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#,*), and/or other keys for operating the mobile terminal.

As shown in FIG. 3, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a universal subscriber identity module (USIM), a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Referring now to FIG. 4, FIG. 4 illustrates a block diagram of an apparatus 402 for facilitating distribution of firmware update packages according to an example embodiment of the invention. In this regard, the apparatus 402 may comprise an embodiment of an apparatus 102 and/or an apparatus 104. Accordingly, the apparatus 402 may be configured to receive a firmware update package by accessing a firmware update package stored on a memory card 104 and/or by receiving a firmware update package provided by a firmware source apparatus 204 over a communication link 206. In the example embodiment illustrated in FIG. 4, the apparatus 402 may include various means, such as a processor 410, memory 412, communication interface 414, user interface 416, and updating circuitry 418 for performing the various functions herein described. These means of the apparatus 402 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 412) that is executable by a suitably configured processing device (for example, the processor 410), or some combination thereof.

The processor 410 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 4 as a single processor, in some embodiments the processor 410 comprises a plurality of processors. The plurality of processors may be in operative communication with each other and may be collectively configured to perform one or more functionalities of the apparatus 402 as described herein. In embodiments wherein the apparatus 402 is embodied as a mobile terminal 10, the processor 410 may be embodied as or comprise the processor 20. In an example embodiment, the processor 410 is configured to execute instructions stored in the memory 412 or otherwise accessible to the processor 410. These instructions, when executed by the processor 410, may cause the apparatus 402 to perform one or more of the functionalities of the apparatus 402 as described herein. As such, whether configured by hardware or software methods, or by a combination thereof, the processor 410 may comprise an entity capable of performing operations according to embodiments of the present invention while configured accordingly. Thus, for example, when the processor 410 is embodied as an ASIC, FPGA or the like, the processor 410 may comprise specifically configured hardware for conducting one or more operations described herein. Alternatively, as another example, when the processor 410 is embodied as an executor of instructions, such as may be stored in the memory 412, the instructions may specifically configure the processor 410 to perform one or more algorithms and operations described herein.

The memory 412 may comprise, for example, volatile memory, non-volatile memory, or some combination thereof. Although illustrated in FIG. 4 as a single memory, the memory 412 may comprise a plurality of memories. In various embodiments, the memory 412 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 402 is embodied as a mobile terminal 10, the memory 412 may comprise the volatile memory 40 and/or the non-volatile memory 42. The memory 412 may be configured to store information, data, applications, instructions, or the like for enabling the apparatus 402 to carry out various functions in accordance with example embodiments of the present invention. For example, in at least some embodiments, the memory 412 is configured to buffer input data for processing by the processor 410. Additionally or alternatively, in at least some embodiments, the memory 412 is configured to store program instructions for execution by the processor 410. The memory 412 may store information in the form of static and/or dynamic information. This stored information may be stored and/or used by the updating circuitry 418 during the course of performing its functionalities.

The communication interface 414 may be embodied as any device or means embodied in circuitry, hardware, a computer program product comprising computer readable program instructions stored on a computer readable medium (for example, the memory 412) and executed by a processing device (for example, the processor 410), or a combination thereof that is configured to receive and/or transmit data from/to another entity. In at least one embodiment, the communication interface 414 is at least partially embodied as or otherwise controlled by the processor 410. In this regard, the communication interface 414 may be in communication with the processor 410, such as via a bus. The communication interface 414 may include, for example, an antenna, a transmitter, a receiver, a transceiver and/or supporting hardware or software for enabling communications with one or more entities. For example, the communication interface 414 may be configured to communicate with a firmware source apparatus 204 over a communication link 106 to enable receipt of a firmware update package provided to the apparatus 404 by the firmware source apparatus 204. As another example, the communication interface 414 may be configured to exchange data, including, for example, a firmware update package, with a memory card 104 that is coupled to the apparatus 404 via a memory card receptacle. The communication interface 414 may be configured to receive and/or transmit data using any protocol that may be used for communications between the apparatus 402 and one or more of a memory card 104 or a firmware source apparatus 204. The communication interface 414 may additionally be in communication with the memory 412, user interface 416, and/or updating circuitry 418, such as via a bus.

The user interface 416 may be in communication with the processor 410 to receive an indication of a user input and/or to provide an audible, visual, mechanical, or other output to a user. As such, the user interface 416 may include, for example, a keyboard, a mouse, a joystick, a display, a touch screen display, a microphone, a speaker, and/or other input/output mechanisms. The user interface 416 may be in communication with the memory 412, communication interface 414, and/or updating circuitry 418, such as via a bus.

The updating circuitry 418 may be embodied as various means, such as circuitry, hardware, a computer program product comprising computer readable program instructions stored on a computer readable medium (for example, the memory 412) and executed by a processing device (for example, the processor 410), or some combination thereof and, in one embodiment, is embodied as or otherwise controlled by the processor 410. In embodiments wherein the updating circuitry 418 is embodied separately from the processor 410, the updating circuitry 418 may be in communication with the processor 410. The updating circuitry 418 may further be in communication with one or more of the memory 412, communication interface 414, or user interface 416, such as via a bus.

The updating circuitry 418 may be configured to detect a firmware update package. The detected firmware update package may comprise a bundled firmware update package comprising a plurality of firmware update packages bundled together as a package. The detected firmware update package may, for example, comprise a diff-based firmware update package. A diff-based firmware update package may comprise updates needed to update from a specific version of firmware to a newer version of firmware (e.g., the differences between the previous version and the newer version). The updating circuitry 418 may, for example, be configured to detect a firmware update package stored on a memory card 104 that is coupled to the apparatus 404 via a memory card receptacle. As another example, the updating circuitry 418 may be configured to detect a firmware update package that is available from a firmware source apparatus 204 via a communication link 206. In this regard, the firmware source apparatus 204 may, for example, be configured to broadcast availability of the firmware update package such that the updating circuitry 418 may detect availability of a firmware update package from the firmware source apparatus 204. Additionally or alternatively, the updating circuitry 418 may be configured to detect the availability of a firmware update package from a firmware source apparatus 204 with which the apparatus 402 has established a proximity-based communication session (e.g., a Bluetooth session), such as by browsing for file(s) stored on the firmware source apparatus 204.

In response to detecting an available firmware update package, the updating circuitry 418 may be configured to access and receive the accessed firmware update package. For example, the updating circuitry 418 may access a firmware update package stored on a memory card 104. As another example, the updating circuitry 418 may be configured to access a firmware update package from a firmware source apparatus 204 by triggering transmission of the firmware update package by the firmware source apparatus 204 over a communication link 206. In this regard, the updating circuitry 418 may be configured to request that the firmware source apparatus 204 transmit the firmware update package, such as in accordance with a communication protocol used for a communication session established between the apparatus 402 and firmware source apparatus 204 over the communication link 206. This communication protocol used for the communication session may, for example, comprise object exchange (OBEX) protocol.

As another example, the updating circuitry 418 may be configured to passively receive a firmware update package provided to the apparatus 402 by a firmware source apparatus 204 over a communication link 206 without first having detected and/or accessed the firmware update package.

The updating circuitry 418 may be configured to use a received firmware update package to update firmware installed on the apparatus 402. If the received firmware update package comprises a bundled firmware update package, the updating circuitry 418 may be configured to determine which, if any, of the firmware update packages included in the bundled firmware update package is appropriate for updating firmware installed on the apparatus 402. This determination may, for example, be made based on a type of firmware installed on the apparatus 402, a version of the firmware installed on the apparatus 402, and/or the like. For example, if ABC firmware is installed on the apparatus 402 and the bundled firmware update package includes a firmware update package for ABC firmware and a firmware update package for XYZ firmware, the updating circuitry 418 may determine that the update package for ABC firmware is the appropriate firmware update package for updating the firmware installed on the apparatus 402.

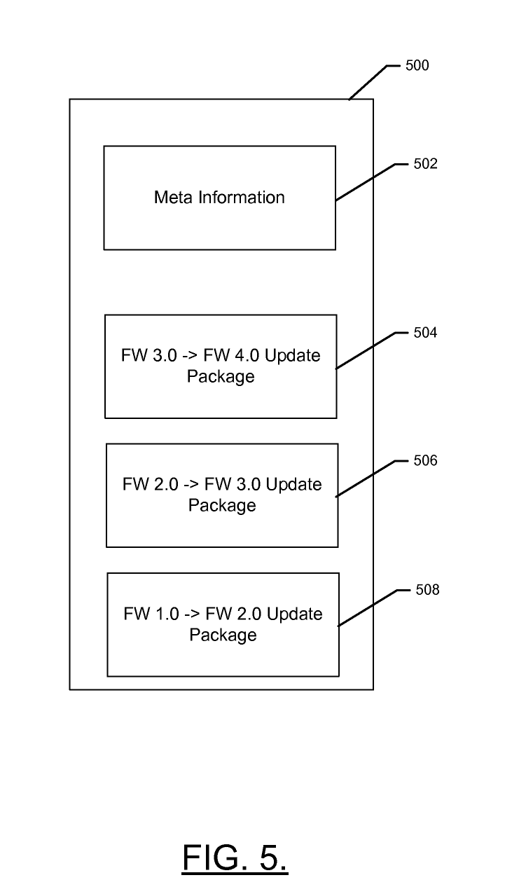

As another example, a bundled firmware update package may comprise a plurality of diff firmware update packages. Each diff firmware update package may comprise updates needed to update from a specific version of firmware to a newer version of firmware (e.g., the differences between the previous version and the newer version). For example, FIG. 5 illustrates a bundled firmware update package 500 according to an example embodiment of the invention. The example bundled firmware update package 500 comprises three firmware update packages: a diff firmware update package 504 comprising updates needed to update from version 3.0 to version 4.0; a diff firmware update package 506 comprising updates needed to update from version 2.0 to version 3.0; and a diff firmware update package 508 comprising updates needed to update from version 1.0 to version 2.0. If version 3.0 is installed on the apparatus 402, the updating circuitry 418 may determine that the diff firmware update package 504 is the appropriate firmware update package for updating the firmware installed on the apparatus 402. If, however, version 2.0 is installed on the apparatus 402, the updating circuitry 418 may determine that diff firmware update package 506 is the appropriate firmware update package for updating the firmware installed on the apparatus 402. It will be appreciated, that once the diff firmware update package 506 has been installed, such that version 3.0 is installed on the apparatus 402, the updating circuitry 402 may further use the diff firmware update package 504 to update the firmware installed on the apparatus 402 to version 4.0. Accordingly, multiple firmware update packages included in a bundled firmware update package may be used to update firmware installed on an apparatus 402 (e.g., to the most recent version).

In some embodiments, a bundled firmware update package may include meta information, such as, for example, the meta information 502 illustrated in the example bundled firmware update package 500. This meta information may provide information about the firmware update packages included in the bundled firmware update package. Accordingly, the updating circuitry 418 may be configured to utilize meta information included in a bundled firmware update package to determine an appropriate firmware update package for updating firmware installed on the apparatus 402.

The updating circuitry 418 may be configured to extract a determined appropriate firmware update package from a bundled firmware update package. The extracted firmware update package may be used by the updating circuitry 418 to update firmware installed on the apparatus 402.

In some embodiments, the updating circuitry 418 is configured to verify a firmware update package. In this regard, a firmware update package may be signed with a digital signature. Accordingly, the updating circuitry 418 may be configured to use the digital signature to verify the authenticity and/or completeness of a firmware update package prior to using the firmware update package to update firmware installed on the apparatus 402. If the updating circuitry 418 cannot verify a firmware update package, the updating circuitry may make a determination not to use the firmware update package. In this regard, installing a firmware update package that is corrupted or has been generated by an untrusted party may cause harm to the apparatus 402 and/or to a user of the apparatus 402, such as by exposing sensitive data stored on the apparatus to third parties, corrupting operation of the apparatus 402, and/or the like.

A bundled firmware update package may include a signature over the entire bundled firmware update package, which may be used by the updating circuitry 418 to verify the bundled firmware update package. Additionally, each individual firmware update package included in the bundled firmware update package may include a signature over the individual firmware update package. Accordingly, the updating circuitry 418 may verify a firmware update package extracted from a bundled firmware update package prior to using the extracted firmware update package to update firmware installed on the apparatus 402.

The updating circuitry 418 may be configured to cause an indication of successful completion of a firmware update to be reported to a network node. The network node may be maintained by a manufacturer of the apparatus 402, firmware distributor, network operator, and/or the like. In this regard, a party maintaining a network node to which firmware updates are reported may keep track of current version(s) of firmware installed on apparatuses in use. The updating circuitry 418 may be configured to include an indication of an identity of the apparatus 402, an indication of a type of firmware installed on the apparatus 402, an indication of a version of firmware installed on the apparatus 402 prior to the update, an indication of a version of firmware installed on the apparatus 402 following the update, an indication of a firmware update package used to update the firmware installed on the apparatus 402, an indication of a source of the firmware update package used to update the firmware installed on the apparatus 402, and/or the like in a communication reporting update of the firmware to a network node. Reporting successful completion of a firmware update may be made by any communication means that allows transmission of a communication from the apparatus 402 to a network node to which firmware updates are reported. For example, reporting firmware update may comprise reporting firmware update via a short message service (SMS) message, email message, instant message, an automated voice call, and/or the like.

In some instances, the apparatus 402 may be configured with a default reporting protocol. For example, in embodiments wherein the apparatus 402 is embodied as a mobile terminal 10, the apparatus 402 may be configured to report completion of a firmware update in accordance with a device management protocol (e.g., Open Mobile Alliance Device Management Protocol, or the like). This default configuration may be appropriate when, for example, receiving a firmware update package via a Firmware Over-The-Air (FOTA) update. However, when a firmware update package is received from a memory card 102 and/or from a firmware source apparatus 204, the default reporting protocol may not be possible or may be improper. Accordingly, the updating circuitry 418 may be configured to bypass and/or disable a default reporting protocol when appropriate.

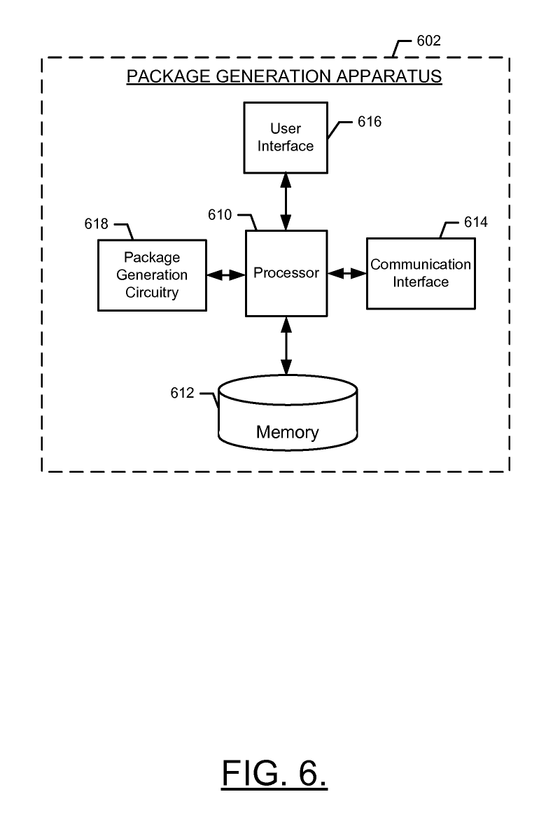

Example embodiments of the invention further provide methods, apparatuses, and computer program products for generating a bundled firmware update package, such as the example bundled firmware update package 500. In this regard, FIG. 6 illustrates a block diagram of a package generation apparatus 602 for generating a bundled firmware update package according to an example embodiment of the invention In the example embodiment illustrated in FIG. 6, the package generation apparatus 602 may include various means, such as a processor 610, memory 612, communication interface 614, user interface 616, and package generation circuitry 618 for performing the various functions herein described. These means of the package generation apparatus 602 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 612) that is executable by a suitably configured processing device (for example, the processor 610), or some combination thereof.

The processor 610 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 6 as a single processor, in some embodiments the processor 610 comprises a plurality of processors. The plurality of processors may be in operative communication with each other and may be collectively configured to perform one or more functionalities of the package generation apparatus 602 as described herein. The plurality of processors may be embodied on a single computing device or may be distributed across a plurality of computing devices collectively configured to perform one or more functionalities of the package generation apparatus 602 as described herein. In an example embodiment, the processor 610 is configured to execute instructions stored in the memory 612 or otherwise accessible to the processor 610. These instructions, when executed by the processor 610, may cause the package generation apparatus 602 to perform one or more of the functionalities of the package generation apparatus 602 as described herein. As such, whether configured by hardware or software methods, or by a combination thereof, the processor 610 may comprise an entity capable of performing operations according to embodiments of the present invention while configured accordingly. Thus, for example, when the processor 610 is embodied as an ASIC, FPGA or the like, the processor 610 may comprise specifically configured hardware for conducting one or more operations described herein. Alternatively, as another example, when the processor 610 is embodied as an executor of instructions, such as may be stored in the memory 612, the instructions may specifically configure the processor 610 to perform one or more algorithms and operations described herein.

The memory 612 may comprise, for example, volatile memory, non-volatile memory, or some combination thereof. Although illustrated in FIG. 6 as a single memory, the memory 612 may comprise a plurality of memories. The plurality of memories may be embodied on a single computing device or distributed across a plurality of computing devices that may collectively comprise the package generation apparatus 602. In various embodiments, the memory 612 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 612 may be configured to store information, data, applications, instructions, or the like for enabling the package generation apparatus 602 to carry out various functions in accordance with example embodiments of the present invention. For example, in at least some embodiments, the memory 612 is configured to buffer input data for processing by the processor 610. Additionally or alternatively, in at least some embodiments, the memory 612 is configured to store program instructions for execution by the processor 610. The memory 612 may store information in the form of static and/or dynamic information. This stored information may be stored and/or used by package generation circuitry 618 during the course of performing its functionalities.

The communication interface 614 may be embodied as any device or means embodied in circuitry, hardware, a computer program product comprising computer readable program instructions stored on a computer readable medium (for example, the memory 612) and executed by a processing device (for example, the processor 610), or a combination thereof that is configured to receive and/or transmit data from/to a device, such as over a network (e.g., wireline network, wireless network, the internet, some combination thereof, or the like). In at least one embodiment, the communication interface 614 is at least partially embodied as or otherwise controlled by the processor 610. In this regard, the communication interface 614 may be in communication with the processor 610, such as via a bus. The communication interface 614 may include, for example, an antenna, a transmitter, a receiver, a transceiver and/or supporting hardware or software for enabling communications with a device over a network. The communication interface 614 may be configured to receive and/or transmit data using any protocol that may be used for communications between entities over a network. In this regard, the communication interface 614 may be configured to transmit a generated bundled firmware update package to another device, such as, for example, to a firmware source apparatus 204. The communication interface 614 may additionally be in communication with the memory 612, user interface 616, and/or package generation circuitry 618, such as via a bus.

The user interface 616 may be in communication with the processor 610 to receive an indication of a user input and/or to provide an audible, visual, mechanical, or other output to a user. As such, the user interface 616 may include, for example, a keyboard, a mouse, a joystick, a display, a touch screen display, a microphone, a speaker, and/or other input/output mechanisms. In embodiments wherein the package generation apparatus 602 is embodied as one or more servers, elements of the user interface 616 may be limited or the user interface 616 may be eliminated entirely. The user interface 616 may be in communication with the memory 612, communication interface 614, and/or package generation circuitry 618, such as via a bus.

The package generation circuitry 618 may be embodied as various means, such as circuitry, hardware, a computer program product comprising computer readable program instructions stored on a computer readable medium (for example, the memory 612) and executed by a processing device (for example, the processor 610), or some combination thereof and, in one embodiment, is embodied as or otherwise controlled by the processor 610. In embodiments wherein the package generation circuitry 618 is embodied separately from the processor 610, the package generation circuitry 618 may be in communication with the processor 610. The package generation circuitry 618 may further be in communication with the memory 612, communication interface 614, and/or user interface 616, such as via a bus.

The package generation circuitry 618 may be configured to generate a bundled firmware update package. In this regard, the package generation circuitry 618 may be configured to assemble a plurality of individual firmware update packages into a single bundled unit for distribution, such as in accordance with the distribution methods described above. One or more of the individual firmware update packages may comprise a diff-based firmware update package. The package generation circuitry 618 may be configured to include meta information in the bundled firmware update package that may provide information about the firmware update packages included in the bundled firmware update package. The package generation circuitry 618 may additionally be configured to generate a digital signature(s) for a bundled firmware update package and/or one or more portions thereof and include the digital signatures in the bundled firmware update package to allow for verification of the bundled firmware update package. For example, the package generation circuitry 618 may be configured to generate a digital signature for each individual firmware update package included in a bundled firmware update package and to generate a digital signature for the entire bundled firmware update package.

The package generation circuitry 618 may be further configured to facilitate distribution of a generated bundled firmware update package by causing the bundled firmware update package to be transmitted to a firmware source apparatus 204, apparatus 402, and/or other apparatus. This transmission may, for example, be made over a network over which the package generation apparatus 602 and apparatus receiving the bundled firmware update package are configured to communicate.

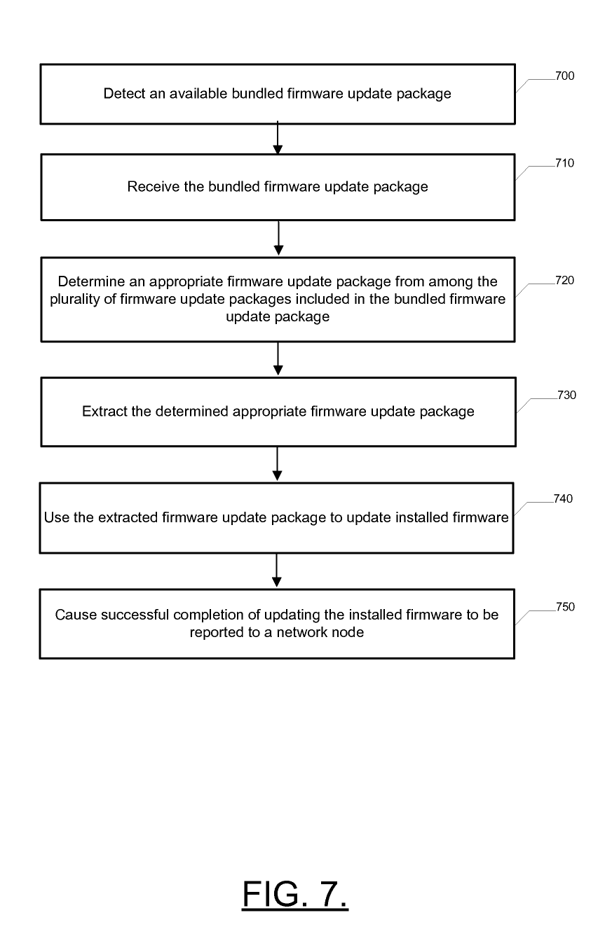

FIG. 7 illustrates a flowchart according to an example method for distributing and updating firmware according to an example embodiment of the invention. In this regard, FIG. 7 illustrates operations that may, for example, be performed at the apparatus 402. The operations illustrated in and described with respect to FIG. 7 may, for example, be performed by and/or under control of one or more of the processor 410, memory 412, communication interface 414, user interface 416, or updating circuitry 418. Operation 700 may optionally comprise detecting an available bundled firmware update package. The detected available bundled firmware update package may, for example, be stored on a memory card or may be accessible via a firmware source apparatus 204. Operation 710 may comprise receiving the bundled firmware update package. If the bundled firmware update package was detected receipt of the bundled firmware update package may occur in response to accessing the bundled firmware update package (e.g., from a memory card) and/or in response to triggering transmission of the bundled firmware update package (e.g., by a firmware source apparatus). Operation 720 may comprise determining an appropriate firmware update package from among the plurality of firmware update packages included in the bundled firmware update package. Operation 730 may comprise extracting the determined appropriate firmware update package. Operation 740 may comprise using the extracted firmware update package to update installed firmware. Operation 750 may optionally comprise causing an indication of successful completion of updating the installed firmware to be reported to a network node.

FIG. 7 is a flowchart of a system, method, and computer program product according to example embodiments of the invention. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories (e.g., memory 412) on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (e.g., the apparatus 402) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (e.g., the processor 410 and/or processor 610) may provide all or a portion of the elements. In another embodiment, all or a portion of the elements may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

In an example embodiment, a method is provided, which comprises receiving a bundled firmware update package. The bundled firmware update package of this embodiment comprises a plurality of firmware update packages. The method of this embodiment further comprises extracting a firmware update package from the bundled firmware update package. The method of this embodiment additionally comprises using the extracted firmware update package to update firmware installed on an apparatus.

The method may further comprise determining an appropriate firmware update package from among the plurality of firmware update packages included in the bundled firmware update package based at least in part upon the firmware installed on the apparatus. Extracting the firmware update package may comprise extracting the determined appropriate firmware update package.

Receiving the bundled firmware update package may comprise receiving a bundled firmware update package stored on a memory card. The method may further comprise detecting the bundled firmware update package stored on the memory card. Receiving the bundled firmware update package may comprise accessing the bundled firmware update package stored on the memory card in response to detecting the bundled firmware update package stored on the memory card.

Receiving the bundled firmware update package may comprise receiving a bundled firmware update package transmitted by a firmware source apparatus over a proximity-based communication link. The method may further comprise detecting availability of the bundled firmware update package. The method may additionally comprise triggering transmission of the bundled firmware update package by the firmware source apparatus in response to detecting availability of the bundled firmware update package. The proximity-based communication link may comprise one of a Bluetooth communication link, a Bluetooth low energy communication link, a communication link implementing an Institute of Electrical and Electronics Engineers 802.15 standard, a ZigBee communication link, an Ultra-Wideband communication link, a near field communication link, an infrared communication link, or the like.

The method may further comprise causing update of the firmware installed on the apparatus to be reported to a network node.

In another example embodiment, an apparatus is provided. The apparatus of this embodiment comprises at least one processor and at least one memory storing computer program code, wherein the at least one memory and stored computer program code are configured to, with the at least one processor, cause the apparatus to at least receive a bundled firmware update package. The bundled firmware update package of this embodiment comprises a plurality of firmware update packages. The at least one memory and stored computer program code are configured to, with the at least one processor, further cause the apparatus of this embodiment to extract a firmware update package from the bundled firmware update package. The at least one memory and stored computer program code are configured to, with the at least one processor, additionally cause the apparatus of this embodiment to use the extracted firmware update package to update firmware installed on an apparatus.

The at least one memory and stored computer program code may be configured, with the at least one processor, to further cause the apparatus to determine an appropriate firmware update package from among the plurality of firmware update packages included in the bundled firmware update package based at least in part upon the firmware installed on the apparatus. The at least one memory and stored computer program code may be configured, with the at least one processor, to cause the apparatus to extract the firmware update package by extracting the determined appropriate firmware update package.

The at least one memory and stored computer program code may be configured, with the at least one processor, to cause the apparatus to receive the bundled firmware update package by receiving a bundled firmware update package stored on a memory card. The at least one memory and stored computer program code may be configured, with the at least one processor, to further cause the apparatus to detect the bundled firmware update package stored on the memory card. The at least one memory and stored computer program code may be configured, with the at least one processor, to cause the apparatus to receive the bundled firmware update package by accessing the bundled firmware update package stored on the memory card in response to detecting the bundled firmware update package stored on the memory card.

The at least one memory and stored computer program code may be configured, with the at least one processor, to cause the apparatus to receive the bundled firmware update package by receiving a bundled firmware update package transmitted by a firmware source apparatus over a proximity-based communication link. The at least one memory and stored computer program code may be configured, with the at least one processor, to further cause the apparatus to detect availability of the bundled firmware update package. The at least one memory and stored computer program code may be configured, with the at least one processor, to additionally cause the apparatus to trigger transmission of the bundled firmware update package by the firmware source apparatus in response to detecting availability of the bundled firmware update package.

The at least one memory and stored computer program code may be configured, with the at least one processor, to further cause the apparatus to cause update of the firmware installed on the apparatus to be reported to a network node.

The apparatus may comprise or may be embodied on a mobile phone, the mobile phone may comprise user interface circuitry and user interface software stored on one or more of the at least one memory. The user interface circuitry and user interface software may be configured to facilitate user control of at least some functions of the mobile phone through use of a display. The user interface circuitry and user interface software may additionally be configured to cause at least a portion of a user interface of the mobile phone to be displayed on the display to facilitate user control of at least some functions of the mobile phone.

In another example embodiment, a computer program product is provided. The computer program product of this embodiment includes at least one computer-readable storage medium having computer-readable program instructions stored therein. The program instructions of this embodiment comprise program instructions configured to receive a bundled firmware update package. The bundled firmware update package of this embodiment comprises a plurality of firmware update packages. The program instructions of this embodiment further comprise program instructions configured to extract a firmware update package from the bundled firmware update package. The program instructions of this embodiment also comprise program instructions configured to use the extracted firmware update package to update firmware installed on an apparatus.

The computer program product may further comprise program instructions configured to determine an appropriate firmware update package from among the plurality of firmware update packages included in the bundled firmware update package based at least in part upon the firmware installed on the apparatus. The program instructions configured to extract the firmware update package may comprise program instructions configured to extract the determined appropriate firmware update package.

The program instructions configured to cause receipt of the bundled firmware update package may comprise program instructions configured to cause receipt of a bundled firmware update package stored on a memory card.

The program instructions configured to cause receipt of the bundled firmware update package may comprise program instructions configured to cause receipt of a bundled firmware update package transmitted by a firmware source apparatus over a proximity-based communication link.

As such, then, some embodiments of the invention provide several advantages to network service providers, apparatus manufacturers, firmware venders, computing devices, and computing device users. Example embodiments of the invention provide a bundled firmware update package that comprises a plurality of firmware update packages. Such example embodiments may facilitate easier distribution of firmware updates in environments where apparatuses having varying versions of firmware are deployed. In this regard, a disseminating device may distribute a bundled firmware update package in accordance with embodiments of the invention without considering a receiving device's current firmware. Further, for purposes of device-to-device distribution, bundled firmware update packages in accordance with example embodiments of the invention may facilitate a more rapid distribution of firmware updates to a community of apparatuses. Example embodiments of the invention additionally provide apparatuses considered to receive bundled firmware update packages over one or more of a proximity-based communication link from another apparatus or via a memory card inserted into a memory card slot. Such example embodiments may allow a user to update the firmware in an apparatus without requiring access to a personal computer and data cable for transfer of a firmware update from the personal computer to the apparatus. Further, such example embodiments may save a user from incurring data transfer fees that might otherwise be incurred if the user were to download a firmware over the air (FOTA) update via a cellular network. Additionally, if a user is located in an area without a network that provides data service suitable for distribution of firmware updates, example embodiments of the invention may still allow the user to update firmware in his apparatus.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving a bundled firmware update package, the bundled firmware update package comprising a plurality of firmware update packages;
extracting, by updating circuitry, a firmware update package from the bundled firmware update package; and
using the extracted firmware update package to update firmware installed on an apparatus.

2. The method of claim 1, further comprising:
determining an appropriate firmware update package from among the plurality of firmware update packages included in the bundled firmware update package based at least in part upon the firmware installed on the apparatus; and
wherein extracting the firmware update package comprises extracting the determined appropriate firmware update package.

3. The method of claim 1, wherein receiving the bundled firmware update package comprises receiving a bundled firmware update package stored on a memory card.

4. The method of claim 3, further comprising:
detecting the bundled firmware update package stored on the memory card; and
wherein receiving the bundled firmware update package comprises accessing the bundled firmware update package stored on the memory card in response to detecting the bundled firmware update package stored on the memory card.

5. The method of claim 1, wherein receiving the bundled firmware update package comprises receiving a bundled firmware update package transmitted by a firmware source apparatus over a proximity-based communication link.

6. The method of claim 5, further comprising:
detecting availability of the bundled firmware update package; and
triggering transmission of the bundled firmware update package by the firmware source apparatus in response to detecting availability of the bundled firmware update package.

7. The method of claim 5, wherein the proximity-based communication link comprises one of a Bluetooth communication link, a Bluetooth low energy communication link, a communication link implementing an Institute of Electrical and Electronics Engineers 802.15 standard, a ZigBee communication link, an Ultra-Wideband communication link, a near field communication link, or an infrared communication link.

8. The method of claim 1, further comprising causing update of the firmware installed on the apparatus to be reported to a network node.

9. An apparatus comprising at least one processor and at least one memory storing computer program code, wherein the at least one memory and stored computer program code are configured, with the at least one processor, to cause the apparatus to at least:
receive a bundled firmware update package, the bundled firmware update package comprising a plurality of firmware update packages;
extract a firmware update package from the bundled firmware update package; and
use the extracted firmware update package to update firmware installed on the apparatus.

10. The apparatus of claim 9, wherein the at least one memory and stored computer program code are configured, with the at least one processor, to further cause the apparatus to:
determine an appropriate firmware update package from among the plurality of firmware update packages included in the bundled firmware update package based at least in part upon the firmware installed on the apparatus; and
extract the firmware update package by extracting the determined appropriate firmware update package.

11. The apparatus of claim 9, wherein the at least one memory and stored computer program code are configured, with the at least one processor, to cause the apparatus to receive the bundled firmware update package by receiving a bundled firmware update package stored on a memory card.

12. The apparatus of claim 11, wherein the at least one memory and stored computer program code are configured, with the at least one processor, to further cause the apparatus to:
detect the bundled firmware update package stored on the memory card; and
receive the bundled firmware update package by accessing the bundled firmware update package stored on the memory card in response to detecting the bundled firmware update package stored on the memory card.

13. The apparatus of claim 9, wherein the at least one memory and stored computer program code are configured, with the at least one processor, to cause the apparatus to receive the bundled firmware update package by receiving a bundled firmware update package transmitted by a firmware source apparatus over a proximity-based communication link.

14. The apparatus of claim 13, wherein the at least one memory and stored computer program code are configured, with the at least one processor, to further cause the apparatus to:
detect availability of the bundled firmware update package; and
trigger transmission of the bundled firmware update package by the firmware source apparatus in response to detecting availability of the bundled firmware update package.

15. The apparatus of claim 9, wherein the at least one memory and stored computer program code are configured, with the at least one processor, to further cause the apparatus to cause update of the firmware installed on the apparatus to be reported to a network node.

16. The apparatus of claim 9, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

17. A computer program product comprising at least one computer-readable storage medium having computer-readable program instructions stored therein, the computer-readable program instructions comprising:
program instructions configured to cause receipt of a bundled firmware update package, the bundled firmware update package comprising a plurality of firmware update packages;
program instructions configured to extract a firmware update package from the bundled firmware update package; and
program instructions configured to use the extracted firmware update package to update firmware installed on an apparatus.

18. The computer program product of claim 17, further comprising:
program instructions configured to determine an appropriate firmware update package from among the plurality of firmware update packages included in the bundled firmware update package based at least in part upon the firmware installed on the apparatus; and
wherein the program instructions configured to extract the firmware update package comprise program instructions configured to extract the determined appropriate firmware update package.

19. The computer program product of claim 17, wherein the program instructions configured to cause receipt of the bundled firmware update package comprise program instructions configured to cause receipt of a bundled firmware update package stored on a memory card.

20. The computer program product of claim 17, wherein the program instructions configured to cause receipt of the bundled firmware update package comprise program instructions configured to cause receipt of a bundled firmware update package transmitted by a firmware source apparatus over a proximity-based communication link.
